(19) United States
(12) Patent Application Publication
(10) Pub. No.: US 2013/0275900 A1
(43) Pub. Date: Oct. 17, 2013

(54) PORTABLE INTERACTIVE INTERFACE FOR INTERVIEW-BASED INVESTIGATIONS

(71) Applicant: University of Florida Research Foundation, Incorporated, (US)

(72) Inventors: Paul Anthony Fishwick, Gainesville, FL (US); Zachary Ezzell, Gainesville, FL (US)

(73) Assignee: University of Florida Research Foundation, Incorporated, Gainesville, FL (US)

(21) Appl. No.: 13/862,902

(22) Filed: Apr. 15, 2013

Related U.S. Application Data
(60) Provisional application No. 61/624,777, filed on Apr. 16, 2012.

(51) Int. Cl. G06F 3/0484

(52) U.S. Cl. CPC G06F 3/04842
USPC 715/767

(57) ABSTRACT

An interactive interface for interview-based investigations is provided in which a process flow diagram is displayed on a portable computing device. When the portable computing device recognizes selection of a node of the process flow diagram, an expansion of the node is displayed overlapping a portion of the process flow diagram. The expansion of the node is presented to allow for data entry (or information display) while displaying the flow chart position.

### BACKGROUND

For many interview-based investigations, the collection of data can be a time consuming process. The process of analyzing the collected data and finding relationships between various items in the collected data can also be difficult. Accordingly, the use of portable computer devices such as tablets is on the rise for facilitating data collection. However, the move from handwritten answers on paper to data-entry on a portable computer device is revealing areas for improvement in the graphical user interface (GUI) metaphors used for data entry.

### BRIEF SUMMARY

Methods and devices are disclosed that present a guided interview tool for facilitating the completion of a particular set of steps according to a set process flow and data entry by prompting a user to fill in certain information and once the information is filled, prompts the user to the next step along a process flow diagram. Nodes of the process flow (e.g., a flow diagram box) can be expanded to enable data entry or to provide information to the user. The expanded nodes become overlapped on screen with the flow diagram so that the user can be aware of their position on the flow chart.

Embodiments of the invention can be used to support contact investigations for infectious diseases such as influenza or tuberculosis, law enforcement investigations, and other interview-based investigations.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1A shows a screen of a flow chart in an expanded view in accordance with an embodiment of the invention.

FIG. 1B shows a screen of a guided flow chart in a regional view around node of the guided flow chart in accordance with an embodiment of the invention.

FIG. 1C shows a screen of an expanded node and portion of the guided flow chart in the regional view around the node in accordance with an embodiment of the invention.

FIG. 1D shows a screen of a guided flow chart in which completed actions are marked in accordance with an embodiment of the invention.

FIG. 2 shows a process flow of a method of presenting a guided flow chart in accordance with an embodiment of the invention.

FIG. 3 shows a process flow of an interview-based investigation in accordance with an embodiment of the invention.

FIG. 4 shows a computing device in accordance with an embodiment of the invention.

### DETAILED DISCLOSURE

Methods and devices are disclosed that present a guided interview tool.

An interview-based investigation generally refers to the research and collection of data based on questions asked of a subject. The interviewer generally asks questions of a subject and records in some manner the answers provided by the subject for later analysis. Most interview-based investigations are conducted using a guide in order to facilitate the collection of relevant data. The guide may be in the form of a documented flowchart or procedure. The answers of the subject may be transcribed through manual or automatic means. In certain cases the subject's answers may be hand written and then later input via a computer to a database. In some cases, the interviewer can directly input the answers via a computing device for immediate or later storage in the database.

The documented flowchart or procedure for an investigation may be provided as a screen on a display of a computing device. In order to provide a better user experience, in accordance with embodiments of the invention, a guided interview tool is provided that transforms a flow chart into a guide and enables data entry at each point on a same screen as the flow chart. The flow chart is not static because there is feedback between the forms (that are filled) and the flowchart.

In accordance with various embodiments of the invention, the guided interview tool guides a user by prompting the user to fill in certain information and once the information is filled, prompts the user to the next step along a process flow diagram. Each node of the process flow can be expanded to enable data entry or to provide information to the user. The expanded nodes become overlapped on screen with the flow diagram so that the user is aware of their position on the flow chart.

The guided interview tool of certain embodiments of the invention utilizes a graphical user interface (GUI) where instead of simply zooming in or out of a region of the flow chart, hidden features are uncovered and expanded on the spot. For example, a window within the flow chart expands in the same screen (with some overlapping) or as an “x-ray” style (or microscope) zoom effect. Selecting a node in the flow chart expands the node and additional information is rendered in the same screen allowing data entry in the expanded screen and not leaving the page having the flow chart.

GUIs enhance the computing experience of the user and facilitate the interaction between a user and a machine by being structured in a manner that resembles a user's real-world experience or familiar knowledge base. That is, GUIs are structured according to one or more metaphors in order to provide a frame of reference to a user. A common GUI metaphor is the desktop, where the screen is treated as a virtual desk and objects are placed on the desk. For example, directories of information are represented as folders that appear to be arranged on the virtual desk. A window can be opened from a file, folder, or document on the virtual desk. In the desktop metaphor, a window of a document may appear as a paper copy on the virtual desk. Metaphors continue to be added, mixed, and modified to provide a user with improved computing experiences. According to certain embodiments of the invention, a microscope metaphor is added to the conventional desktop metaphor arrangement.

Embodiments of the invention can be used to support contact investigations for infectious diseases such as influenza or tuberculosis, law enforcement investigations, and other interview-based investigations.

According to one implementation, a portable interface for interview-based investigations is provided that guides a user (e.g., public health worker) along a flowchart (such as distributed by SE National Tuberculosis Center). As the user is guided along the flowchart, he or she is provided with additional information and data-entry forms that correspond to a given flowchart step (e.g., in Tuberculosis investigations, the step “take medical history” will provide data entry fields in which the medical history may be entered). Information entered by users includes personal and medical history of the index case (e.g., the person with Tuberculosis), and social contacts and visited places of the index case.

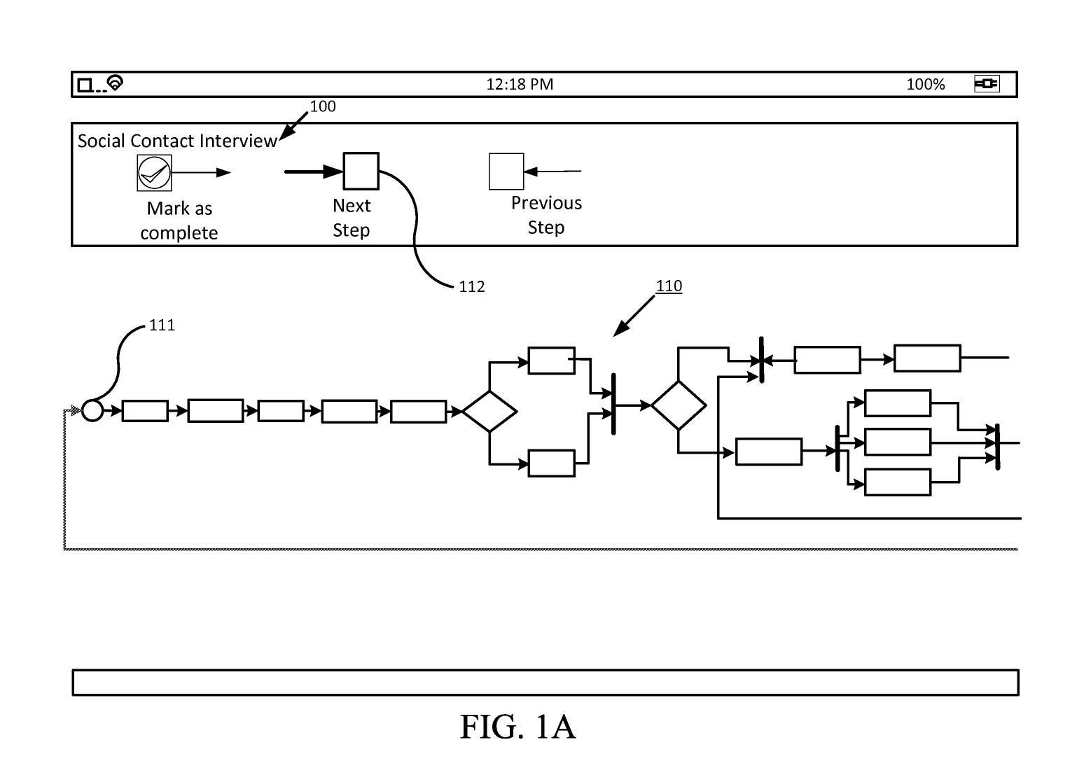

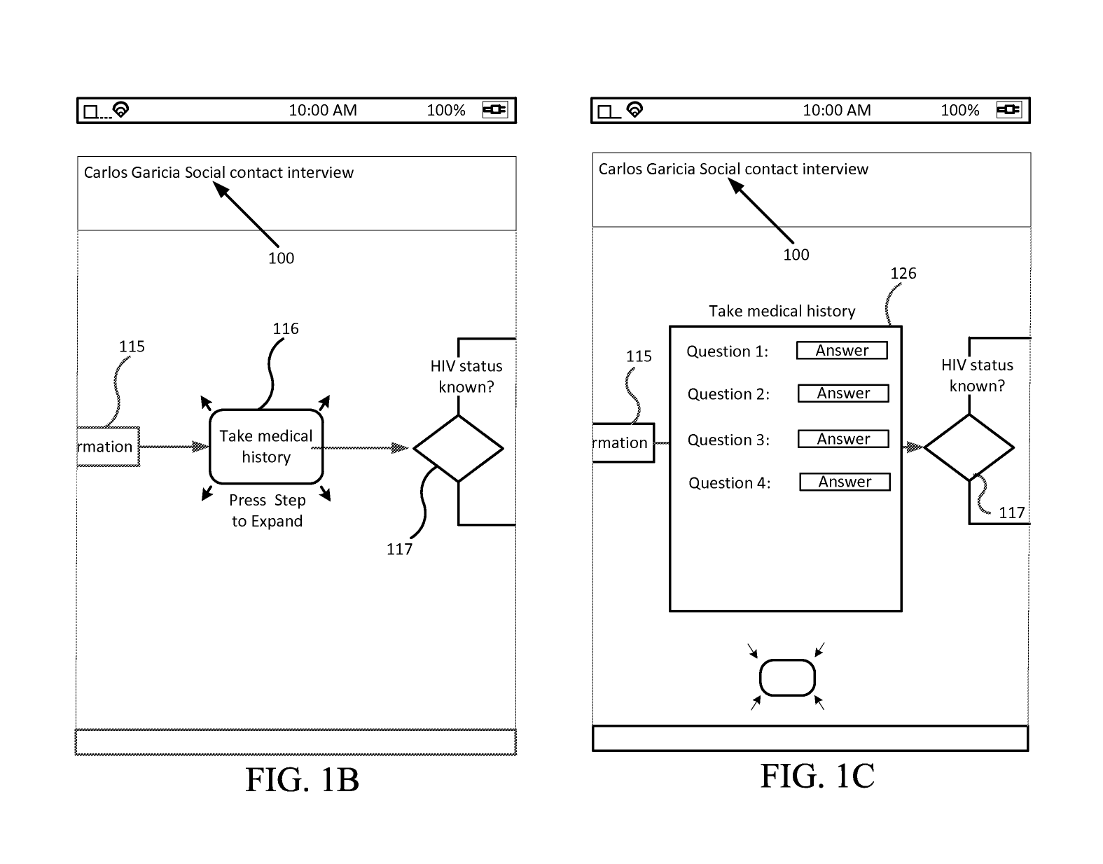

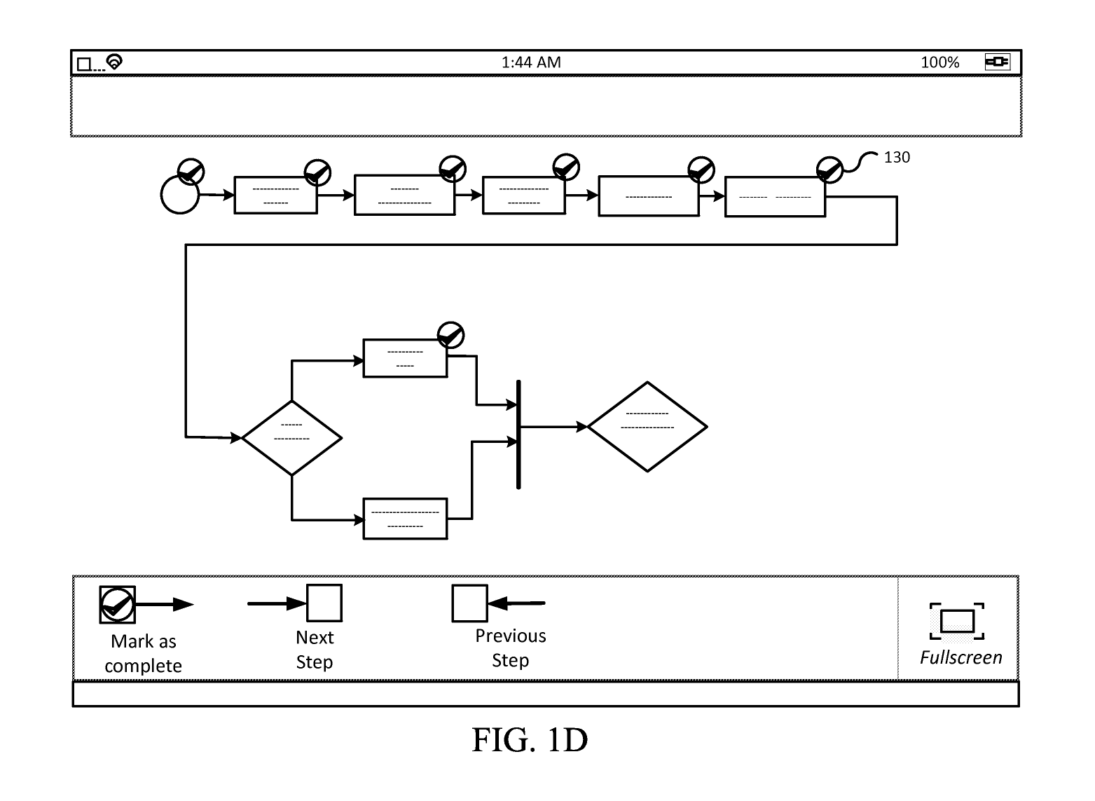

An example implementation is illustrated in FIGS. 1A-1D. Referring to FIG. 1A, a user interface is provided in which a guided flow chart is presented. In the example shown in FIG. 1A, a social contact interview guide 100 is illustrated as a flow chart 110. This flow chart interface can be implemented on any suitable portable computing device such as a tablet. A user can conduct an interview-based investigation and be guided and prompted to fill in the required information according to the flow chart. Regional views of the flow chart can be made prominent through using any suitable zooming function in which a region of the flow chart is made prominent in the view screen. During the social contact interview a user begins at a start node 111 and is guided to each step of the interview according to the flow chart. A tool bar item “next step” 112 may be selected by touch (when the interface is presented on a touch-screen device) or by another user input mechanism (e.g., mouse) in order to progress along the flow chart. Alternatively, or in addition, a user can directly select the flow chart diagram box on the flow chart.

In one embodiment, the flow chart is zoomed to a regional view upon selection of the start node and the interactive interface remains in the regional view size as the user progresses through the flow chart unless the user makes a selection to view the larger flow chart.

When the flow chart diagram box is touched by the user, the data input section for the selected diagram box expands on the screen. For example, FIG. 1B shows a regional view of the step “take medical history” 116 in the social contact interview guide 100. When a user selects the diagram box, the diagram box expands into take medical history data input section 126 as shown in FIG. 1C. In contrast to the traditional hyperlinked window that may take the entire screen (or be provided in a split screen effect at a side of the screen) when a user follows hyperlinks to navigate through the system, certain embodiments of the invention utilize a microscope metaphor in which the data input features of the diagram box are like microscopic cells in a sample on a slide being viewed under a microscope. Thus, selecting the diagram box brings forward the features not generally visible. In this case, the features being made visible by the selection of the diagram box is the data input section. In accordance with embodiments of the invention, the microscope effect is specific to the selected diagram box and not the diagram boxes also visible in the original regional view of the selected diagram box. For example, as shown in FIGS. 1B and 1C, the regional view of the “take medical history” 116 diagram box includes a display of a previous step diagram box 115 and a next step diagram box 117, and the previous step diagram box 115 and the next step diagram box 117 are still visible when the take medical history data input section 126 expands onto the screen. The presentation of both the data entry section and the pre- and post-steps in the process flow diagram can facilitate contextual understanding of the user to where in the process flow the user is located.

In a further embodiment, the expansion of the diagram box can be animated. In one embodiment, the animation of the expansion of the node (or diagram box) can appear as if continuous magnification were applied on a microscope within the same window as the regional view.

It should be understood that each diagram box may not contain a data input section and, if expandable, may instead provide additional information to assist the user in performing the step. In both cases, when a diagram box is expanded, a view screen with the expanded node and portion of the regional view can be presented.

As shown in FIG. 1D, as the user completes each step, an indication that the step is complete can be provided on the flow chart. For example, a check-mark 130 can be shown on the diagram box representing a completed step.

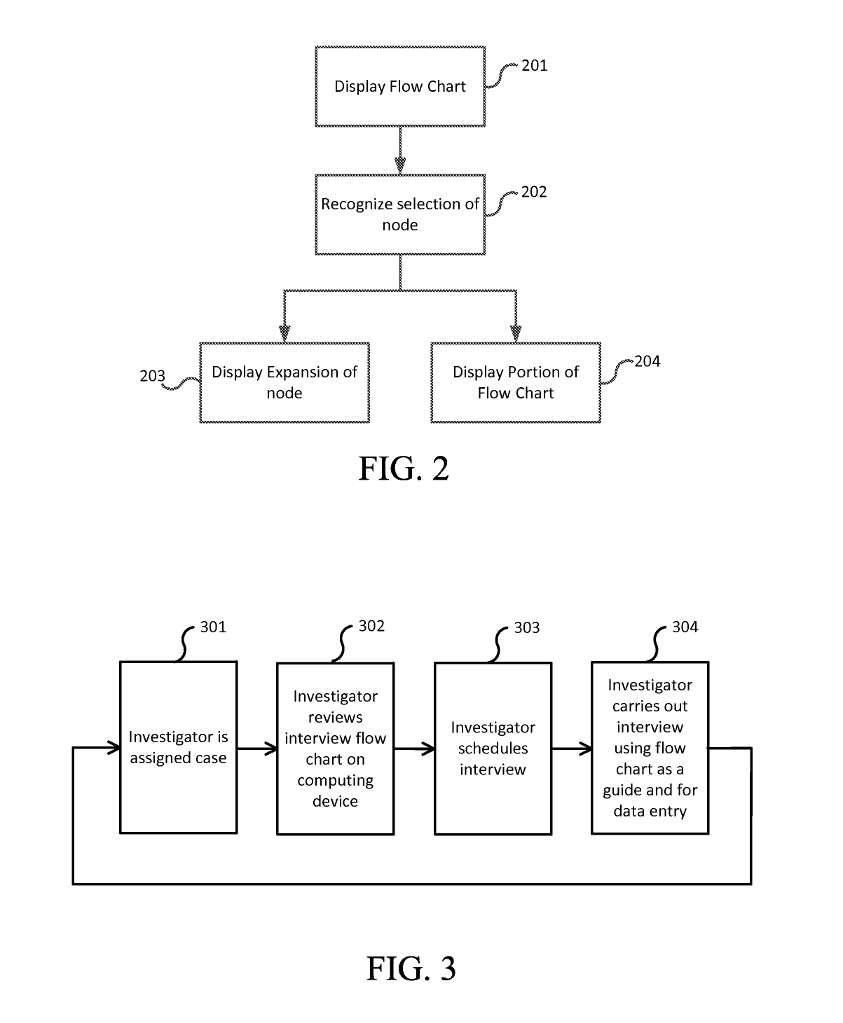

FIG. 2 shows a process flow of a method of presenting a guided flow chart in accordance with an embodiment of the invention. Referring to FIG. 2, the flow chart is displayed on a screen 201. Input of a selection of a node can be accomplished in a variety of methods such as touch (when using a computing device with a touch screen) or using a cursor or mouse pointer (when using a computing device with a mouse or other input device). The system recognizes selection of a node 202 and displays expansion of the node 203 as well as the portion of the flow chart 204 not covered by the expanded node. Accordingly, when a node is selected in the flowchart, it is possible to spot zoom in to the node, which “magnifies” (according to the microscope metaphor) to reveal a form where values can be entered (or presents additional information to the user in the form of text, images, or video). Not only does the node become “magnified” to reveal the form where values can be entered (or information be presented to the user), but the node appears to be expanded on the screen with the non-expanded portions reflected in their previous size on the screen. The expansion of the node can be animated. In one embodiment, the animation of the expansion of the node can appear as if continuous magnification were applied on a microscope to spot expand the node within the same window as the flow chart while revealing portions of the flow chart around the expanded node.

FIG. 3 shows a process flow of an interview-based investigation in accordance with an embodiment of the invention. As shown in FIG. 3, once an investigator is assigned a case 301, the investigator may review interview flow chart on a computing device 302. The flow chart can be in the form such as shown in FIG. 1A. After scheduling an interview with a subject 303, the investigator can carry out the interview using an interactive interview flow chart for data entry 304. The interactive interview flow chart can have an interface as described with respect to FIGS. 1A-1D.

Certain techniques set forth herein may be described in the general context of computer-executable instructions, such as program modules, executed by one or more computers or other devices. Generally, program modules include routines, programs, objects, components, and data structures that perform particular tasks or implement particular abstract data types. Certain embodiments of the invention contemplate the use of a computer system or virtual machine presented as a computing device within which a set of instructions, when executed, can cause the system to perform any one or more of the methodologies discussed above. The instructions may be stored on one or more computer-readable media.

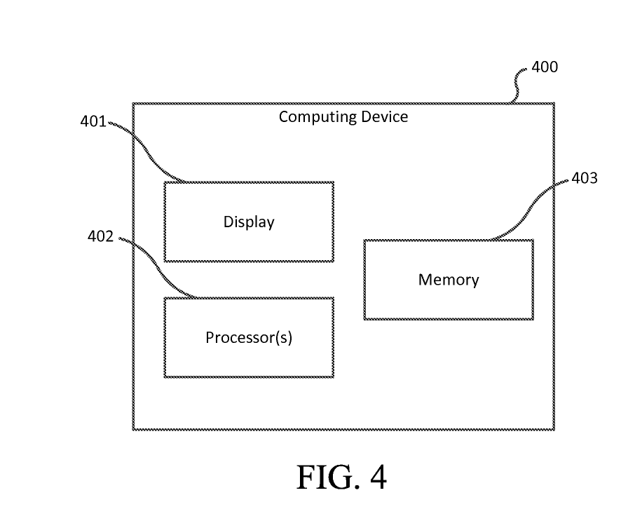

FIG. 4 shows a computing device which can execute a guided flow chart in accordance with an embodiment of the invention. As shown in FIG. 4, a computing device 400 can have a touch screen display 401, one or more processors 402, and a memory 403 storing instructions for operating the computing device to provide an interactive guided flow chart. It should be understood that the computing device can include other suitable components beyond those specifically described.

For example, the computer system of the computing device can have hardware including one or more computer processing units (CPUs), memory, mass storage (e.g., hard drive), and I/O devices (e.g., network interface, user input devices). Elements of the computer system hardware can communicate with each other via a bus. The computer system hardware can be configured according to any suitable computer architectures such as a Symmetric Multi-Processing (SMP) architecture or a Non-Uniform Memory Access (NUMA) architecture. The one or more CPUs may include multiprocessors or multi-core processors and may operate according to one or more suitable instruction sets including, but not limited to, a Reduced Instruction Set Computing (RISC) instruction set, a Complex Instruction Set Computing (CISC) instruction set, or a combination thereof. In certain embodiments, one or more digital signal processors (DSPs) may be included as part of the computer hardware of the system in place of or in addition to a general purpose CPU.

It should be appreciated by those skilled in the art that computer-readable media include removable and non-removable structures/devices that can be used for storage of information, such as computer-readable instructions, data structures, program modules, and other data used by a computing system/environment. A computer-readable medium includes, but is not limited to, volatile memory such as random access memories (RAM, DRAM, SRAM); and non-volatile memory such as flash memory, various read-only-memories (ROM, PROM, EPROM, EEPROM), magnetic and ferromagnetic/ferroelectric memories (MRAM, FeRAM), and magnetic and optical storage devices (hard drives, magnetic tape, CDs, DVDs); or other media now known or later developed that is capable of storing computer-readable information/data. Computer-readable media should not be construed or interpreted to include any propagating signals.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

It should be understood that the examples and embodiments described herein are for illustrative purposes only and that various modifications or changes in light thereof will be suggested to persons skilled in the art and are to be included within the spirit and purview of this application.

We claim:

1. A method of presenting an interactive interface for an interview-based investigation, the method comprising:
displaying a process flow diagram on a display of a computing device;
recognizing selection of a node of the process flow diagram; and
in response to the selection of the node of the process flow diagram, displaying a portion of the process flow diagram in which the node is located and an expansion of the node overlapping the portion of the process flow diagram on the display of the computing device.

2. The method according to claim 1, wherein displaying the process flow diagram comprises:
displaying a full flow of the process flow diagram; and
in response to receiving a selection of a start node of the process flow diagram, displaying a regional view of the process flow diagram, wherein a view of the process flow diagram remains in the regional view until a selection of a larger view is received.

3. The method according to claim 2, further comprising:
recognizing a completion of a task performed at the node; and
in response to the completion of the task performed at the node, adjusting the view of the process flow diagram being displayed to guide a user along the process flow diagram to a next node while remaining in the regional view.

4. The method according to claim 1, wherein the expansion of the node comprises a data entry section.

5. The method according to claim 1, wherein the displaying of the expansion of the node overlapping a portion of the process flow diagram comprises:
displaying an animation of the expansion of the node within a same window and location as the portion of the process flow diagram in which the node is located.

6. The method according to claim 1, wherein the expansion of the node reveals supplemental information or features relevant to a task of the process flow diagram represented by the node.

7. The method according to claim 1, further comprising:
recognizing a completion of a task performed at the node; and
in response to the completion of the task performed at the node, adjusting a view of the process flow diagram being displayed to guide a user along the process flow diagram to a next node.

8. A computer readable medium having computer-readable instructions stored thereon that, when executed by a processor, cause a computing device to perform a method of presenting an interactive interface for an interview-based investigation comprising:
displaying a process flow diagram on a display of the computing device;
recognizing selection of a node of the process flow diagram; and
in response to the selection of the node of the process flow diagram, displaying a portion of the process flow diagram in which the node is located and an expansion of the node overlapping the portion of the process flow diagram on the display of the computing device.

9. The medium according to claim 8, wherein displaying the process flow diagram comprises:
displaying a full flow of the process flow diagram; and
in response to receiving a selection of a start node of the process flow diagram, displaying a regional view of the process flow diagram, wherein a view of the process flow diagram remains in the regional view until a selection of a larger view is received.

10. The medium according to claim 9, wherein the method further comprises:
recognizing a completion of a task performed at the node; and
in response to the completion of the task performed at the node, adjusting the view of the process flow diagram being displayed to guide a user along the process flow diagram to a next node while remaining in the regional view.

11. The medium according to claim 8, wherein the expansion of the node comprises a data entry section.

12. The medium according to claim 8, wherein the displaying of the expansion of the node overlapping a portion of the process flow diagram comprises:
displaying an animation of the expansion of the node within a same window and location as the portion of the process flow diagram in which the node is located.

13. The medium according to claim 8, wherein the expansion of the node reveals supplemental information or features relevant to a task of the process flow diagram represented by the node.

14. The medium according to claim 8, wherein the method further comprises:
recognizing a completion of a task performed at the node; and
in response to the completion of the task performed at the node, adjusting a view of the process flow diagram being displayed to guide a user along the process flow diagram to a next node.

15. A computing device comprising:
a touch screen display;
one or more processors; and
a memory having stored thereon instructions that, when executed by the one or more processors, cause the computing device to:
display a process flow diagram on the touch screen display;
recognize a selection of a node of the process flow diagram; and
in response to the selection of the node of the process flow diagram, display a portion of the process flow diagram in which the node is located and an expansion of the node overlapping the portion of the process flow diagram on the touch screen display.

16. The computing device according to claim 15, wherein the instructions, when executed by the one or more processors, cause the computing device to display of the process flow diagram on the touch screen display by:
displaying a full flow of the process flow diagram; and
in response to receiving a selection of a start node of the process flow diagram, displaying a regional view of the process flow diagram.

17. The computing device according to claim 15, wherein the expansion of the node comprises a data entry section.

18. The computing device according to claim 15, wherein the instructions, when executed by the one or more processors, cause the computing device to display the expansion of the node overlapping a portion of the process flow diagram by:
displaying an animation of the expansion of the node within a same window and location as the portion of the process flow diagram in which the node is located.

19. The computing device according to claim 15, wherein the expansion of the node reveals supplemental information or features relevant to a task of the process flow diagram represented by the node.

20. The computing device according to claim 15, wherein the instructions, when executed by the one or more processors, further cause the computing device to:
recognize a completion of a task performed at the node; and
in response to the completion of the task performed at the node, adjust a view of the process flow diagram being displayed to guide a user along the process flow diagram to a next node.
